(19) United States
(12) Patent Application Publication
(10) Pub. No.: US 2025/0102115 A1
(43) Pub. Date: Mar. 27, 2025

(54) SIGHT GLASS INDICATOR FOR TANK FAILURE

(71) Applicant: Amtrol Licensing Inc., West Warwick, RI (US)

(72) Inventors: Nicholas W. BOLCON, Coventry, RI (US); Bryan VARELA, Cumberland, RI (US)

(21) Appl. No.: 18/820,973

(22) Filed: Aug. 30, 2024

Related U.S. Application Data
(60) Provisional application No. 63/539,887, filed on Sep. 22, 2023.

(51) Int. Cl. F17C 13/02

(52) U.S. Cl. CPC F17C 13/02; F17C 2205/037; F17C 2250/0413; F17C 2260/038

(57) ABSTRACT

A tank with an angled indicator assembly is disclosed. A flexible membrane may be connected to an inner wall of a shell of the tank and separates a tank cavity into a first chamber sealed to contain a pressurized gas and a second chamber sealed to contain a pressurized fluid. The tank may include an indicator assembly that includes a coupling connected to an exterior of the shell. A sight cap with a transparent viewing window can operably connect to coupling. The coupling and the sight cap define an internal viewing pocket in fluid communication with the first chamber of the tank cavity. The coupling may connect to the shell at an angle defined by the angle of a longitudinal axis of the coupling relative to a longitudinal axis of the tank.

### CROSS-REFERENCE TO RELATED APPLICATIONS

This application claims priority to and the benefit of U.S. Provisional Application No. 63/539,887, filed on Sep. 22, 2023, the entirety of which is incorporated herein by reference.

### TECHNICAL FIELD

In general, the present invention relates to expansion tanks, and more particularly, to diaphragm expansion tanks having an indicator to alert a user if fluid is present in the gas side of an expansion tank.

### BACKGROUND OF THE INVENTION

Expansion tanks are commonly used in heating, cooling and air condition systems, hot water, and water storage systems to avoid unacceptable increase of system pressures during heat-up, generally by absorbing expanding fluid and limiting pressure within the system and to store water. Use of an expansion tank can increase pump life. Expansion tank designs include open tanks, closed compression tanks, and pre-charged diaphragm or bladder tanks.

In a pre-charged expansion tank, a diaphragm or bladder is used to separate air from water within the tank. In particular, one side of the tank is connected to piping of a heating system (or other system) and therefore contains the water, while the other side contains air under pressure. A Schrader valve is typically provided at the air side of the tank for checking pressure and adding air, which allows the pressure of the tank to be adjusted as needed.

An air/gas charge pressure on one side keeps the diaphragm/bladder at a distance away from the inside wall of the tank in the gas side. When the tank is installed onto a water system, the water system pressure pushes back against the diaphragm, compressing the gas. When the system is cold and the water in the tank is at the minimum level, the tank pressure is at an initial/pre-charge pressure. As the temperature in the system increases, the water expands to compress the gas chamber via the diaphragm or bladder, causing an increase in the gas and water system pressure.

However, the diaphragm has a limited life. Various failure modes for expansion tanks include incorrect precharge pressure (e.g. a low air precharge), excessive system pressure, diaphragm failure resulting in leak of air charge, and installation of an incorrectly sized tank (e.g. undersized tank which causes the diaphragm to overwork), all of which can lead to quick cycling or over-pressurization and ultimately failure. In such failure modes, the diaphragm can develop a pinhole, an abrasion, a cut or the like that allows water to enter the gas side of the tank. Over time, the gas will be absorbed into the water system and the gas charge will decrease to zero. At this point, the tank is considered waterlogged and ineffective. This can eventually cause failure of other equipment in the system or failure of the tank itself, resulting in water leakage into space surrounding the tank.

In order to determine whether there are problems in the expansion tank operation or if the expansion tank has failed, a homeowner or building owner must often require the services of a plumber to remove the tank from the system and perform tests. This is time consuming and expensive. Failure of these tanks may diminish the efficiency of the water and/or HVAC system and may also introduce foreign materials, like metals, into potable water over time. Ultimately, failure of these tanks can lead to downtime of the building itself and damage to home and commercial buildings.

### SUMMARY OF THE INVENTION

In accordance with an embodiment of the present invention, a tank with an angled indicator assembly is disclosed. The tank may include a housing having an upper dome, a lower dome opposite the upper dome and a shell connecting the upper dome and the lower dome and defining a cavity. The tank may further include a flexible membrane positioned within the cavity and connected to an inner wall of the shell. The flexible membrane may separate the cavity into a first chamber sealed to contain a pressurized gas and a second chamber sealed to contain a pressurized fluid. The tank may also include a coupling with a first end and a second end opposite the first end. The first end of the coupling can be connected to an exterior of the shell proximate the lower dome. The tank may include a sight cap having a transparent viewing window configured to operably connect to the second end of the coupling. The coupling and the indicator may define an internal viewing pocket that is in fluid communication with the first chamber of the cavity. The coupling and sight glass may be connected to the shell at a coupling angle defined by the angle of a longitudinal axis of the coupling and indicator relative to a vertical axis.

The tank may also include a plurality of openings in the shell that provide fluid communication between the first chamber of the cavity and the viewing pocket. The plurality of openings may be configured to create turbulent flow within the viewing pocket.

In one aspect, a tank includes a housing defining a cavity. A flexible membrane is positioned within the cavity, and separates the cavity into a first chamber and a second chamber. The tank further includes an indicator assembly coupled to the housing. The indicator assembly includes a coupling with a first end and a second end opposite the first end, the first end connected to an exterior of the housing at a coupling angle between a longitudinal axis of the coupling and a vertical axis of the tank. The coupling angle is less than 90 degrees. The indicator assembly further includes a sight cap coupled to the second end of the coupling and having a transparent viewing window, the sight cap and the coupling defining an internal viewing pocket that is in fluid communication with the first chamber of the cavity.

In one embodiment, the housing has a plurality of openings to provide the fluid communication between the first chamber of the cavity and the internal viewing pocket.

In one embodiment, the first chamber is configured to contain a pressurized gas, and the second chamber is configured to contain a fluid.

In one embodiment, the indicator assembly is configured to indicate the presence of the fluid within the first chamber.

In one embodiment, the plurality of openings are configured to produce a turbulent flow of the fluid within the internal viewing pocket when a level of the fluid inside the first chamber exceeds a height of at least one opening of the plurality of openings.

In one embodiment, the tank further includes a float disposed within the internal viewing pocket.

In one embodiment, the float has a lower density than the fluid.

In one embodiment, the float is configured to float on the fluid when the fluid enters the internal viewing pocket.

In one embodiment, the plurality of openings is two holes.

In one embodiment, the two holes are arranged parallel with a vertical axis of the tank.

In one embodiment, the coupling angle is in the range of 45 to 75 degrees.

In one embodiment, the coupling angle is 75 degrees.

In another aspect, the tank includes a housing defining a cavity, and a flexible membrane positioned within the cavity, where the flexible membrane separates the cavity into a first chamber and a second chamber. The tank further includes an indicator assembly coupled to the housing, the indicator assembly including an internal viewing pocket that is in fluid communication with the first chamber of the cavity. The housing has a plurality of openings configured to provide the fluid communication between the first chamber of the cavity and the internal viewing pocket.

In one embodiment, the plurality of openings is two holes.

In one embodiment, the two holes are arranged parallel with a vertical axis of the tank.

In one embodiment, the indicator assembly is coupled to an exterior wall of the housing at a coupling angle between a longitudinal axis of the indicator assembly and a vertical axis of the tank, where the coupling angle is less than 90 degrees.

In one embodiment, the coupling angle is in the range of 45 to 75 degrees.

In one embodiment, the coupling angle is 75 degrees.

In another aspect, the tank includes a housing defining a cavity, and a flexible membrane positioned within the cavity, the flexible membrane separating the cavity into a first chamber configured to contain a pressurized gas and a second chamber configured to contain a fluid. The tank further includes an indicator assembly coupled to an exterior wall of the housing and extending from the exterior wall at a coupling angle between a longitudinal axis of the indicator assembly and a vertical axis of the tank. The indicator assembly includes an internal viewing pocket that is in fluid communication with the first chamber of the cavity. The coupling angle is less than 90 degrees, and the housing has a plurality of openings configured to provide the fluid communication between the first chamber of the cavity and the internal viewing pocket. The plurality of openings are configured to produce a turbulent flow of the fluid within the internal viewing pocket when a level of the fluid inside the first chamber exceeds a height of at least one opening of the plurality of openings.

In one embodiment, the coupling angle is in the range of 45 to 75 degrees.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of an expansion tank with a sight glass indicator.

FIG. 2 is a front view of the expansion tank with the sight indicator.

FIG. 3 is a left side view of the expansion tank with the sight glass indicator

FIG. 4 shows cross section A and provides a cross section view of the left side of the expansion tank.

FIG. 5 shows cross section B and provides a cross section view of the rear of the expansion tank providing an internal view of the tank.

FIG. 6 shows cross section C and provides a perspective cross section view of the sight glass assembly installed on the tank wall.

FIG. 7 is a perspective view of the sight glass assembly.

FIG. 8 is a rear view of the sight glass assembly.

FIG. 9 shows cross section D and provides a cross section view of the sight glass assembly.

FIG. 10 shows cross section C and provides an exploded cross section view of the sight glass assembly.

FIG. 11 shows cross section view and provides an illustration of the turbulent flow produced in the internal viewing pocket.

FIG. 12 is a perspective view of an alternative embodiment of an expansion tank with a sight glass indicator.

FIG. 13 is a front view of thereof.

FIG. 14 is a left side view of the alternative embodiment.

FIG. 15 shows cross section E and provides a cross section view of the left side of the alternative embodiment.

FIG. 16 shows cross section F and provides a cross section view of the rear of the alternative embodiment providing an internal view of the tank.

FIG. 17 is a perspective view of a horizontal embodiment of an expansion tank with a sight glass indicator.

FIG. 18 is a front view of horizontal embodiment.

FIG. 19 is a right side view of the horizontal embodiment.

FIG. 20 shows cross section G and provides a cross section view of the left side of the horizontal embodiment.

FIG. 21 shows cross section H and provides a cross section view of the rear of the horizontal embodiment providing an internal view of the tank.

### DETAILED DESCRIPTION OF THE INVENTION

Embodiments of the invention relate to an angled indicator assembly on the side wall of an expansion tank. Expansion tanks can include a viewing apparatus allowing a user to see into a chamber of the tank to look for the presence of fluid. Existing solutions are ineffective for a variety of reasons. First, the viewing apparatus may be placed low on the tank wall perpendicular to the ground and therefore may be difficult to use. For instance, a user would need to get very low to the ground to a position where their eyesight is approximately level with the viewing apparatus. To make use of the viewing apparatus more convenient, the viewing apparatus can be placed near the top of the tank. This is also ineffective because the viewing apparatus at the top of the tank can only indicate a leak once the water level inside the tank has risen to the same level as the viewing apparatus. Most or all of the tank could be filled with water before the leak is detected and the entire tank may fail potentially leading to damage to the system. Additionally, if the viewing apparatus is perpendicular to the tank wall, there may be only a brief period of time where the level of fluid is noticeable to the eye. For instance if the fluid is clear, like water, a user may falsely indicate there is no leak because the user may not be able to detect the difference between a normal expansion tank with no water in the viewing apparatus and an expansion tank with a failed bladder where the viewing apparatus is completely filled with water.

The disclosed indicator assembly addresses these issues. The indicator assembly is a sight glass that can be angled upwards, away from the ground toward the user. Because the indicator assembly is angled, the sight glass can be positioned low on the tank allowing a user to use the sight glass without having to get low to the ground. The angled sight glass can trap an air bubble in the indicator as the water level continues to rise, distinctly showing the presence of fluid in the air chamber of the expansion tank. The angled sight glass can further include a float disposed within the sight glass that distinctly indicates the presence of fluid when the float is located at the top of the sight glass. Further, the tank may have a plurality of holes in communication with the sight glass. These holes may create turbulent flow within the angled sight glass that agitates the water, air bubble, and float within the angled sight glass. This angled sight glass provides for early, quick, and clear detection of bladder failure within the tank. Earlier detection of failure of the bladder or diaphragm may prevent further damage to the tank and to the water system.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

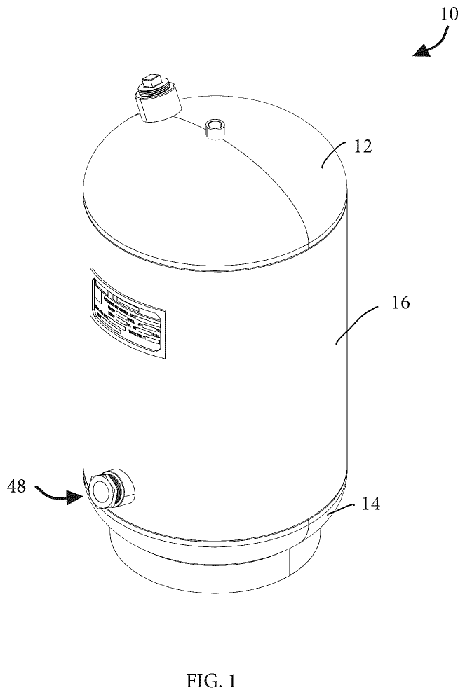

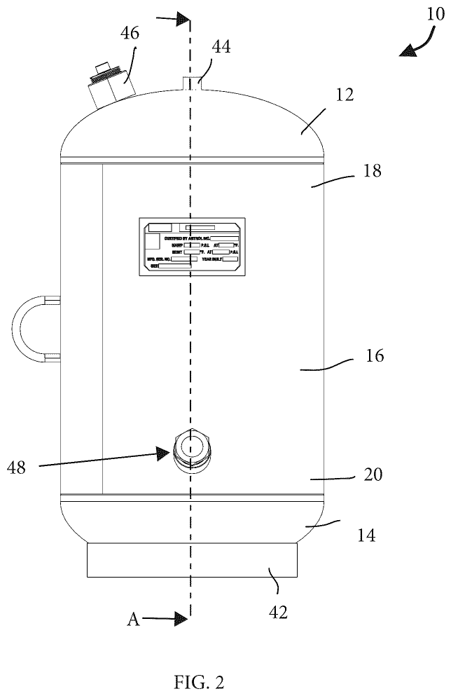

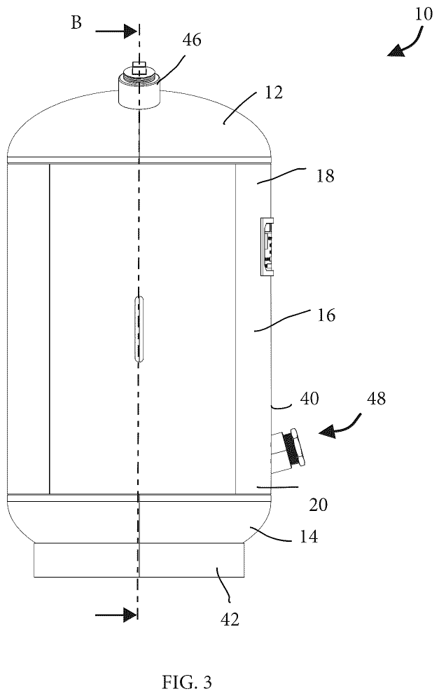

Turning now to FIGS. 1-6, an exemplary tank is illustrated generally at reference numeral 10. The tank 10 can be a well or expansion tank used in a water or HVAC system. The tank 10 includes a housing that can include an upper dome 12, a lower dome 14, and a shell 16 having a first end 18 connected to the upper dome 12 and a second end 20 connected to the lower dome. The upper dome 12, lower dome 14, and shell 16 define a cavity 22 when connected together. The tank 10 can be made of any material suitable to withstand the pressure of the water or HVAC system like metal, polymer, a composite material, etc. The upper dome 12, a lower dome 14, and shell 16 can be connected to each other by welding, friction welding, crimping, or any other suitable manner depending on the material of the tank 10. FIGS. 1-6, 10 and 11 illustrate the tank 10 in a vertical orientation. It will be appreciated that the tank can have other orientations, such as a horizontal orientation, that will be discussed in further detail below.

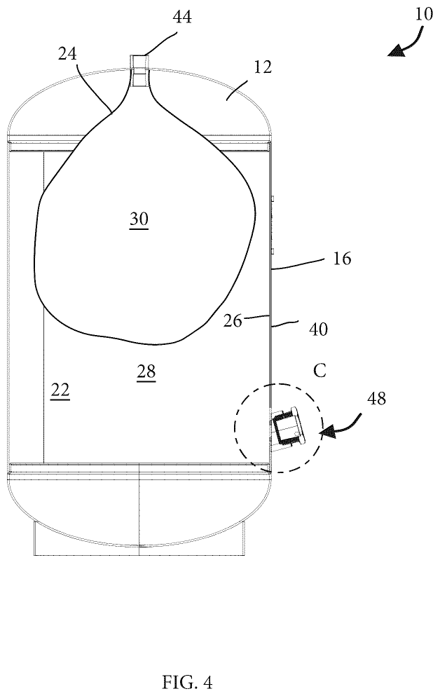

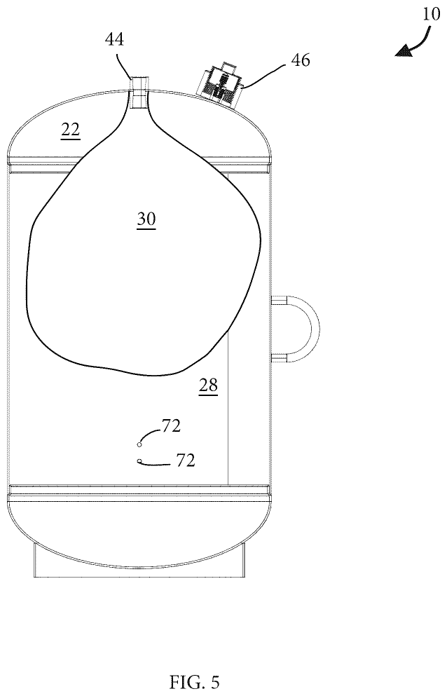

The tank 10 can further include a flexible membrane 24 configured to be attached to an interior wall 26 of the cavity 22. The flexible membrane 24 divides the cavity 22 into a first chamber 28 configured to sealably receive a pressurized gas and a second chamber 30 configured to sealably receive a pressurized fluid. The flexible membrane 24 can be a bladder, a diaphragm, or any other suitable flexible membrane that can be connected to the interior wall to create the first and second chambers of the cavity. The flexible membrane 24 can be attached to the interior wall 26 proximate the second end of the shell 16. In other embodiments, the flexible membrane 24 can be attached at or surrounding the fluid valve assembly 44. It will be appreciated that the method and location of connecting the flexible membrane 24 can be selected by sound engineering judgment based on the desired performance of the tank. It should be appreciated that while the flexible membrane 24 is shown as a bladder connected to the fluid valve assembly 44 in FIGS. 4 and 5, the flexible membrane 24 can also be a diaphragm that is attached to an interior wall 26. In these embodiments, the air valve assembly 46 may be located at a location beneath where the diaphragm is attached, to create fluid communication between the air valve assembly 46 and the first chamber 28.

The tank 10 further includes an exterior wall 40. The tank can include a foot 42 configured to connect to the exterior wall 40 at the lower dome 14 of the tank 10. One side of the foot 42 can be connected to the tank and the opposite side of the foot may rest on a substrate below the tank 10, for instance the ground. In an alternative embodiment, the tank may not include a foot and the tank may be supported by the pipes of the water or HVAC system. To provide fluid communication between the second chamber 30 and the water system or HVAC system, a fluid valve assembly 44 may be coupled to the tank 10. As illustrated in FIGS. 1-5, the fluid valve assembly 44 may be coupled to the upper dome of the tank 12. Alternatively, depending on the use and position of the tank 10 in the system, the fluid valve assembly 44 may also be coupled to the lower dome 14 or shell 16 of the tank 10. The tank 10 can have a precharge of pressurized air in the first chamber 28. This precharge may need to be periodically refilled to ensure proper function of the tank 10. To provide fluid communication to the first chamber 28 to return the air pressure in the first chamber 28 to a desired precharge, an air valve assembly 46 may be coupled to the tank 10. As illustrated in FIGS. 1-5, the air valve assembly 46 may be coupled to the upper dome of the tank 12. Alternatively, depending on the use and position of the tank 10 in the system, and/or the type and position of the flexible membrane 24, the air valve assembly 46 may also be coupled to the lower dome 14 or shell 16 of the tank 10. The air valve assembly 46 can include a Schrader valve or any other suitable valve.

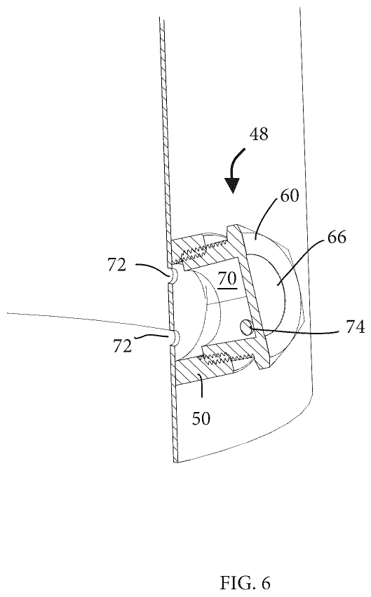

To allow for detection of the failure of the flexible membrane 24 and therefore presence of liquid in the first chamber 28 of the cavity 22, an indicator assembly 48 may be connected to the exterior wall 40 of the tank 10. To allow early detection of the failure of the flexible membrane 24, the indicator assembly 48 may be connected to the tank 10 proximate the second end 20 of the shell 16 by the lower dome 14. As illustrated in FIGS. 5-6 and as will be described in further detail below, the shell 16 of the tank 10 may have a plurality of openings 72 extending through the shell to provide fluid communication between the indicator assembly 48 and the first chamber 28 of the cavity 22. Alternatively, in other embodiments, the upper dome 12 or the lower dome 14 may have a plurality of openings 72 extending through it to provide fluid communication between the indicator assembly 48 and the first chamber 28 of the cavity 22. If the flexible membrane 24 fails and fluid is present in the first chamber 28 of the cavity 22, positioning the plurality of openings 72 and the indicator assembly 48 proximate the second end 20 of the shell 16 will allow for earlier detection compared to any indicator positioned near the first end 18 of the tank 10 because the indicator assembly will fill with liquid when the fluid level is still low in the tank. The plurality of openings 72 also allows the indicator assembly 48 to fill quicker because some air in the indicator assembly 48 can escape through one of the plurality of openings 72 and more fluid can flow through a plurality of openings 72 than through a single opening. As illustrated in FIGS. 5 and 6, the tank may have two openings 72 providing fluid communication between the first chamber 28 of the cavity 22 and the indicator assembly 48. In one embodiment, the tank includes two circular openings 72. However, it will be appreciated that any suitable number of openings and any suitable shape openings may be used as determined by sound engineering judgment.

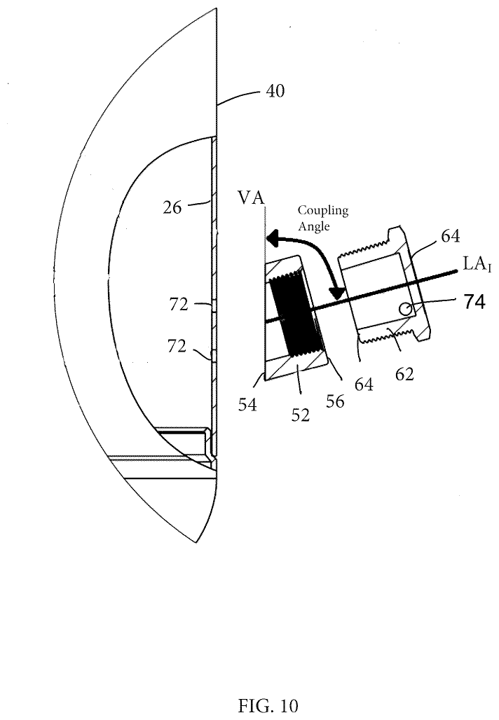

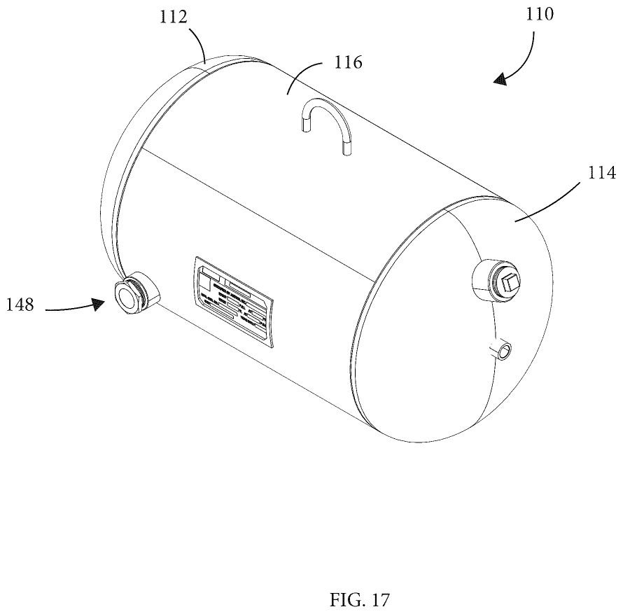

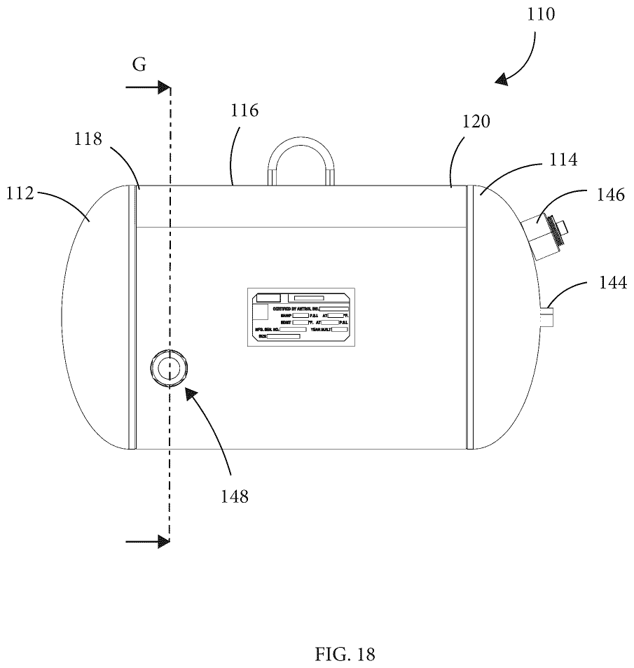

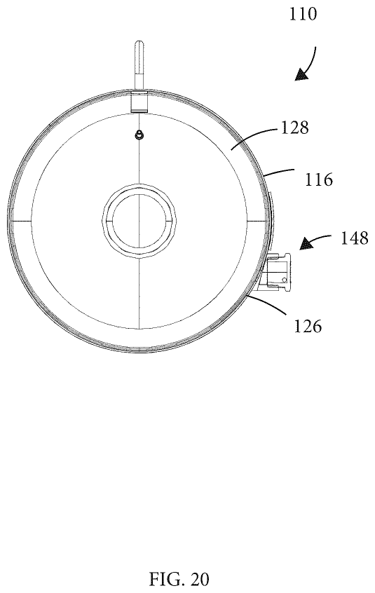

The indicator assembly 48 can be configured to connect to the exterior wall 40 at a coupling angle defined between a vertical axis VA of the tank 10 parallel with the exterior wall 40 of the tank 10 and coaxial with a centerline of the tank 10 and a longitudinal axis LAI of the indicator assembly parallel and coaxial with a centerline of the indicator assembly 48. The vertical axis VA is defined as an axis parallel to the longitudinal axis of the tank 10 having a vertical configuration, or an axis perpendicular to the longitudinal axis of the tank having a horizontal configuration (described in greater detail below with respect to FIGS. 17-21). The coupling angle can be less than 90 degrees, and in the range of approximately 40 to 80 degrees. As illustrated in FIG. 10, the coupling angle can be approximately 75 degrees. As will be further described in detail below, the indicator assembly 48 can be connected to the exterior wall 40 by welding or any other suitable mechanical coupling means. Connecting the indicator assembly 48 at an angle allows a user to use the indicator assembly 48 to detect failure of the flexible membrane 24 without having to get to a low position to view the indicator assembly 48. For instance, because of the coupling angle, the user may be able to see the indicator assembly 48 and detect a possible leak while standing upright and looking at the indicator assembly 48 from above.

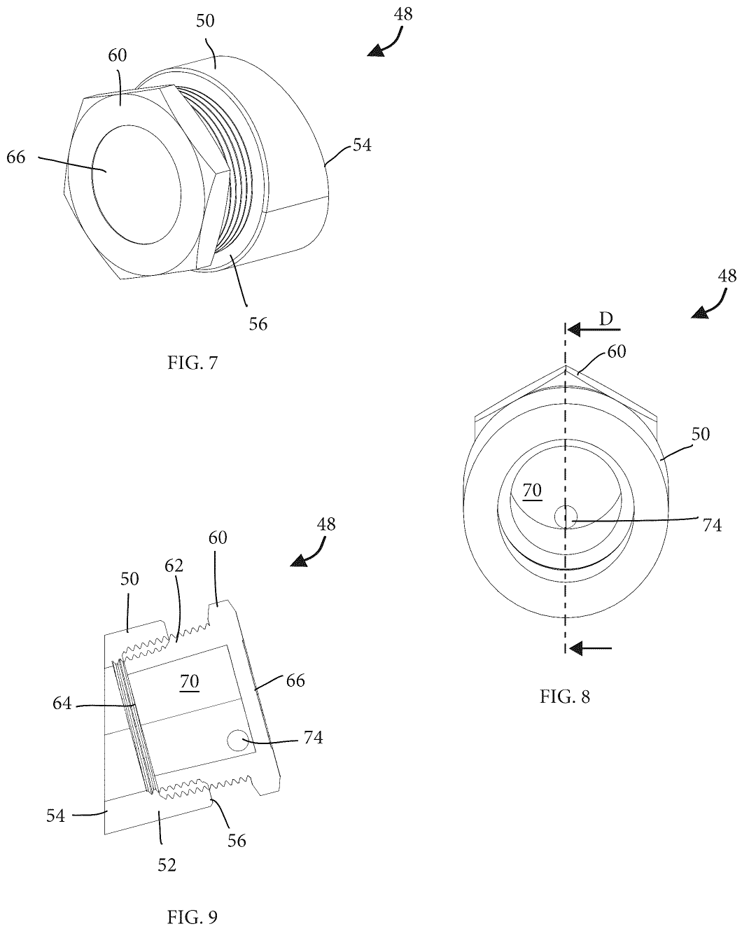

Turning now to FIGS. 7-10, the indicator assembly 48 will be described in detail. The indicator assembly can have a coupling 50 that is configured to operably connect to a sight cap 60. As illustrated, the coupling 50 can have a substantially cylindrical and hollow coupling body 52 with a first side 54 and a second side 56 opposite the first side 54. The first side 54 and the second side 56 may be open so that the coupling 50 is tubular. Similarly, the sight cap 60 can have a substantially cylindrical and hollow sight cap body 62, an open side 64, and a closed end 66 opposite the open side 64 of the sight cap 60. Alternatively, the coupling 50 and sight cap 60 may be some other geometry, like rectangular or square tubing, provided the coupling 50 and sight glass 60 can be configured to operably connect to each other.

To attach the coupling 50 to the tank 10, the first side 54 of the coupling body 52 can be configured to connect to the exterior wall 40 of the tank 10, for instance by welding, a threaded connection, or some other suitable mechanical fastening means. In another embodiment, the first side of the coupling body 52 can be configured to connect to either the upper dome 12 or lower dome 14, for instance by welding, a threaded connection, or some other suitable mechanical fastening means. To assemble the indicator assembly 48, the second side 56 of the coupling body 52 can be configured to operably receive the open side 64 of the sight cap body 62. For instance, as illustrated in FIGS. 6-10, the second side 56 of the coupling body 52 can include internal threads configured to engage external threads at the open side 64 of the sight cap body 62. Alternatively, the coupling body 52 may have external threads configured to engage internal threads on the sight cap body 62. Further, the coupling 50 and sight cap 60 may be connected by welding, using a plurality of fasteners, or any other suitable means. It will be further appreciated that the coupling 50 and sight cap 60 may be one piece configured to connect to the exterior wall 40 of the tank.

Once assembled, the hollow coupling body 52 and the hollow sight cap body 52 form an internal viewing pocket 70 between the exterior wall 40 of the tank 10, interior of the coupling body 52, the interior of the sight cap 62, and the closed end 66 of the sight cap 60. The closed end 66 of the sight cap 60 can be a translucent or transparent material, like glass, polymer, or some other suitable material, that allows a user of the tank to see into the internal viewing pocket 70. The coupling 50 can be installed on the exterior wall 40 of the tank 10 such that it is aligned with the plurality of openings 72 and the internal viewing pocket 70 is in fluid communication with the first chamber 28 of the cavity 22. A float 74 may be disposed within the internal viewing pocket 70. The float 74 may have a density lower than the density of the fluid in the tank, so that it floats on the surface of the fluid if a fluid fills the internal viewing pocket 70. The float 74 can be a bright color to provide additional visual indication of the presence of fluid in the internal viewing pocket 70. The float 74 can be substantially spherical or any other suitable shape.

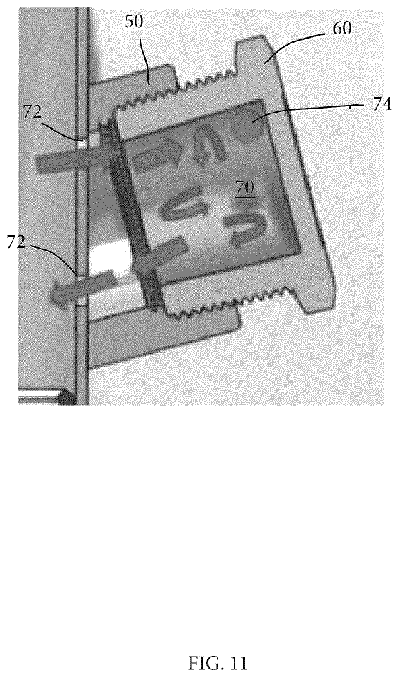

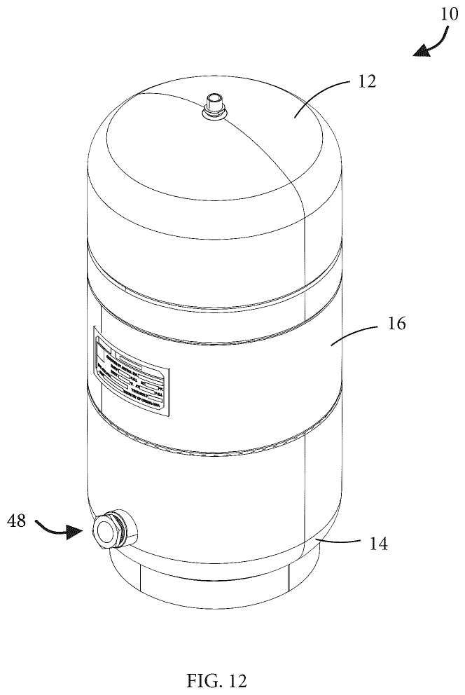

If the flexible membrane 24 fails and the first chamber 28 of the cavity 22 begins to fill with fluid, the plurality of openings 72 are configured to allow the fluid to flow into the internal viewing pocket 70. As illustrated in FIGS. 5-6 and 11, the two openings 72 are positioned vertically with respect to each other. As illustrated, in the vertical tank orientation, one of the two openings 72 is placed above the other parallel with the longitudinal axis of the vertical tank 10. In this configuration, the openings are positioned such that fluid will begin to flow into the bottom opening first and then the second opening above the bottom opening. The configuration of the openings 72 and angular connection of the indicator assembly 48 to the exterior wall 40 can create a turbulent flow of the fluid, as illustrated by the arrows in the internal viewing pocket 70 in FIG. 11. This turbulent flow also prevents a failed flexible membrane 24 from blocking a single opening in the shell 16 thereby preventing fluid from entering the internal viewing pocket 70. Additionally, an air bubble can become trapped within the internal viewing pocket 70 as fluid fills the viewing pocket because the indicator assembly 48 is connected to the exterior wall 40 at the coupling angle.

Therefore, the indicator assembly 48 provides multiple means of detecting failure of the flexible membrane 24. The presence of fluid can be seen in the internal viewing pocket 70 as water levels in the cavity 22 of the tank 10 rise. The configuration of the plurality of openings 72 creates a turbulent flow that may be indicated by movement of the fluid and splashing within the internal viewing pocket 70. If the fluid in the cavity 22 of the tank 10 exceeds the height of the plurality of openings 72, the user can see a distinct line between the trapped air bubble and the fluid in internal viewing pocket 70. In such a situation, some amount of turbulence is still produced within the internal viewing pocket 70 even when the fluid in the cavity 22 of the tank 10 exceeds the height of the plurality of openings 72. Finally, all of these detection modes can be enhanced if a float 74 is disposed within internal viewing pocket 70. In certain embodiments that include the detection modes mentioned above, the brightly colored float 74 would respectively move with the rising fluid line, would be agitated by the turbulent flow, and/or would be floating on the end of the fluid line and trapped air bubble.

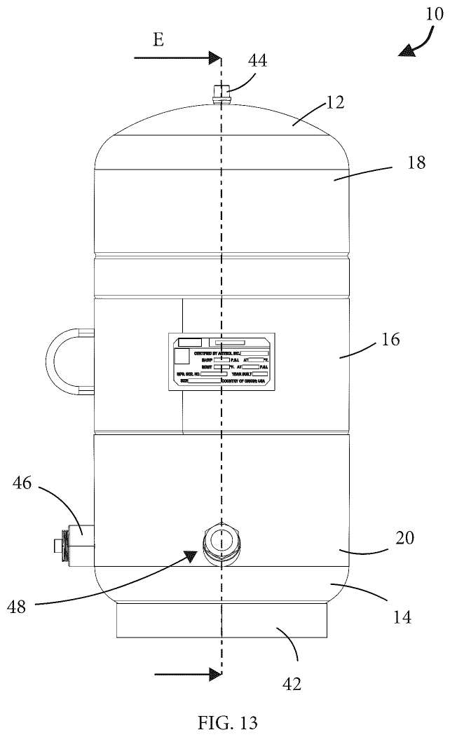

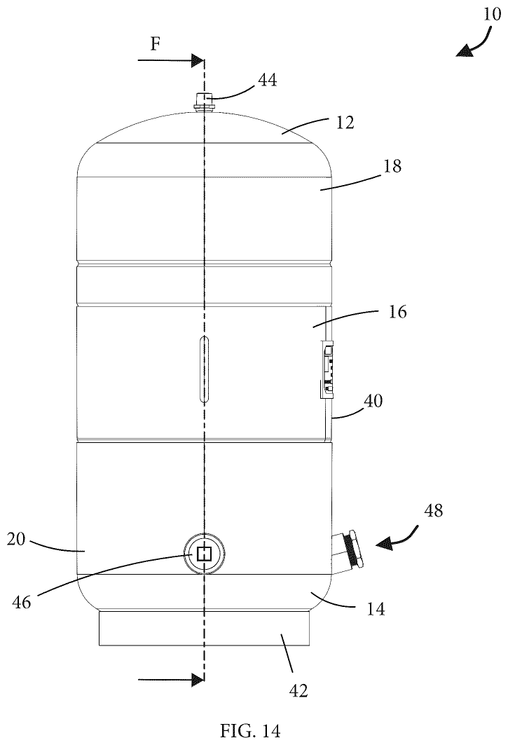

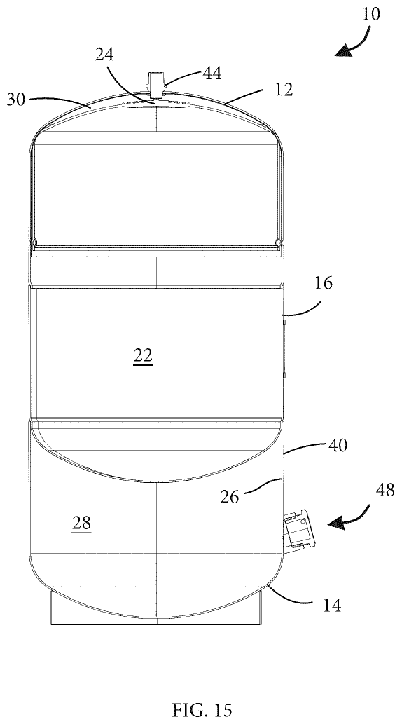

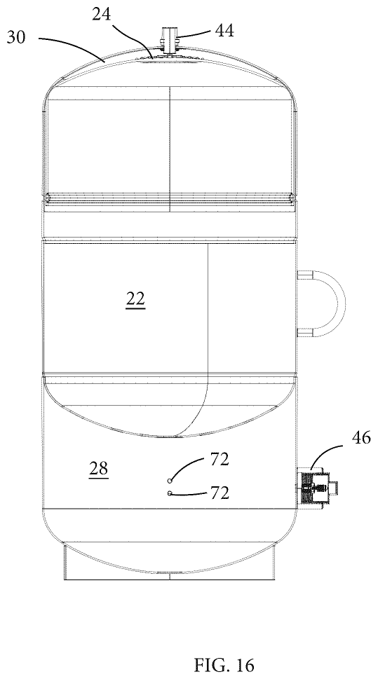

Turning now to FIGS. 12-16, another embodiment of a tank 110 is shown. This particular embodiment is substantially similar to the embodiment of FIGS. 1-5, except the flexible membrane 124 is arranged as a diaphragm, and the air valve assembly 46 is located on the lower half of the tank 10, proximate to the lower dome 14. It should be appreciated that the air valve assembly 46 can be located on the lower dome 14.

Turning now to FIGS. 17-21, the tank 110 can be a horizontal tank 110. Unless otherwise noted below, the description of the above tank applies to the horizontal tank 110 as well. The tank 110 includes a first side dome 112, a second side dome 114, and a shell 116 having a first end 118 connected to the first side dome 112 and a second end 120 connected to the second side dome 114. The first side dome 112, second side dome 114, and shell 116 define a cavity 122 when connected together. The tank 110 can be made of any material suitable to withstand the pressure of the water or HVAC system like metal, polymer, a composite material, etc. The first side dome 112, a second side dome 114, and shell 116 can be connected to each other by welding, friction welding, crimping, or any other suitable manner depending on the material of the tank 110.

The tank 110 can further include a flexible membrane 124 configured to be attached to an interior wall 126 of the cavity 122. The flexible membrane 124 divides the cavity 122 into a first chamber 128 configured to sealably receive a pressurized gas and a second chamber 130 configured to sealably receive a pressurized fluid. In this embodiment, the tank 110 can have a fluid valve assembly 144 in either the first side dome 112, the second side dome 114, or shell 116. The position of the fluid valve assembly 144 can be determined by sound engineering judgment and the purpose of the tank 110. The tank 110 can have an air valve assembly 146 in either the first side dome 112, the second side dome 114, or shell 116. The position of the fluid valve assembly 146 can be determined by sound engineering judgment and the purpose of the tank 110.

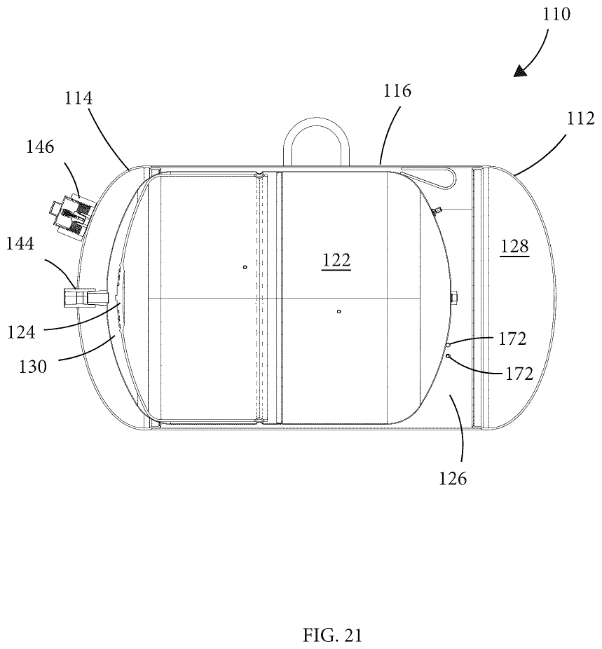

In this embodiment, the indicator assembly 148 can be coupled to the first side dome 112, the second side dome 114, or the shell 116. The tank 110 can have a plurality of openings 172 that provides fluid communication between the first chamber 128 and the indicator assembly 148. If the flexible membrane 124 fails and the first chamber 128 of the cavity 122 begins to fill with fluid, the plurality of openings 172 are configured to allow the fluid to flow into indicator assembly 148. As illustrated in FIG. 21, the two openings 172 are positioned vertically with respect to each other. As illustrated, in the horizontal tank orientation, one of the two openings 172 is placed above the other perpendicular to the longitudinal axis of the horizontal tank 110. In this configuration, the openings are positioned such that fluid will begin to flow into the bottom opening first and then the second opening above the bottom opening.

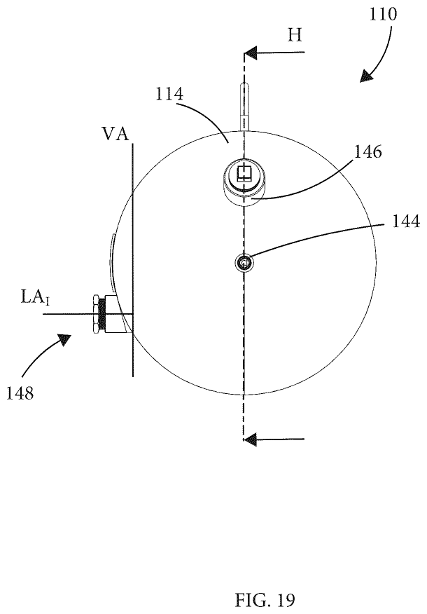

As shown in FIG. 19, the indicator assembly 148 can be configured to connect to the exterior wall at a coupling angle defined between a vertical axis VA of the tank 110 perpendicular to the longitudinal axis of the horizontally oriented tank 110 and a longitudinal axis LAI of the indicator assembly parallel and coaxial with a centerline of the indicator assembly 148. The coupling angle can be less than 90 degrees, and in the range of approximately 40 to 80 degrees.

The aforementioned systems, components, (e.g., tanks, domes, shells, cavities, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the apparatus, systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A tank comprising:
a housing defining a cavity;
a flexible membrane positioned within the cavity, the flexible membrane separating the cavity into a first chamber and a second chamber; and
an indicator assembly coupled to the housing, the indicator assembly comprising:
a coupling with a first end and a second end opposite the first end, the first end connected to an exterior of the housing at a coupling angle between a longitudinal axis of the coupling and a vertical axis of the tank, wherein the coupling angle is less than 90 degrees; and
a sight cap coupled to the second end of the coupling and having a transparent viewing window, the sight cap and the coupling defining an internal viewing pocket that is in fluid communication with the first chamber of the cavity.

2. The tank of claim 1, wherein the housing has a plurality of openings to provide the fluid communication between the first chamber of the cavity and the internal viewing pocket.

3. The tank of claim 2, wherein the first chamber is configured to contain a pressurized gas, and the second chamber is configured to contain a fluid.

4. The tank of claim 3, wherein the indicator assembly is configured to indicate the presence of the fluid within the first chamber.

5. The tank of claim 3, wherein the plurality of openings are configured to produce a turbulent flow of the fluid within the internal viewing pocket when a level of the fluid inside the first chamber exceeds a height of at least one opening of the plurality of openings.

6. The tank of claim 3, further comprising a float disposed within the internal viewing pocket.

7. The tank of claim 6, wherein the float has a lower density than the fluid.

8. The tank of claim 7, wherein the float is configured to float on the fluid when the fluid enters the internal viewing pocket.

9. The tank of claim 2, wherein the plurality of openings is two holes.

10. The tank of claim 9, wherein the two holes are arranged parallel with a vertical axis of the tank.

11. The tank of claim 1, wherein the coupling angle is in the range of 45 to 75 degrees.

12. The tank of claim 11, wherein the coupling angle is 75 degrees.

13. A tank comprising;
a housing defining a cavity;
a flexible membrane positioned within the cavity, the flexible membrane separating the cavity into a first chamber and a second chamber; and
an indicator assembly coupled to the housing, the indicator assembly comprising an internal viewing pocket that is in fluid communication with the first chamber of the cavity,
wherein the housing has a plurality of openings configured to provide the fluid communication between the first chamber of the cavity and the internal viewing pocket.

14. The tank of claim 13, wherein the plurality of openings is two holes.

15. The tank of claim 14, wherein the two holes are arranged parallel with a vertical axis of the tank.

16. The tank of claim 13, wherein the indicator assembly is coupled to an exterior wall of the housing at a coupling angle between a longitudinal axis of the indicator assembly and a vertical axis of the tank, wherein the coupling angle is less than 90 degrees.

17. The tank of claim 16, wherein the coupling angle is in the range of 45 to 75 degrees.

18. The tank of claim 17, wherein the coupling angle is 75 degrees.

19. A tank comprising;
a housing defining a cavity;
a flexible membrane positioned within the cavity, the flexible membrane separating the cavity into a first chamber configured to contain a pressurized gas and a second chamber configured to contain a fluid; and
an indicator assembly coupled to an exterior wall of the housing and extending from the exterior wall at a coupling angle between a longitudinal axis of the indicator assembly and a vertical axis of the tank, the indicator assembly comprising an internal viewing pocket that is in fluid communication with the first chamber of the cavity,
wherein the coupling angle is less than 90 degrees, and
wherein the housing has a plurality of openings configured to provide the fluid communication between the first chamber of the cavity and the internal viewing pocket, and the plurality of openings are configured to produce a turbulent flow of the fluid within the internal viewing pocket when a level of the fluid inside the first chamber exceeds a height of at least one opening of the plurality of openings.

20. The tank of claim 19, wherein the coupling angle is in the range of 45 to 75 degrees.
